(19) United States
(12) Patent Application Publication
(10) Pub. No.: US 2016/0054949 A1
(43) Pub. Date: Feb. 25, 2016

(54) METHOD FOR STORING DATA IN A COMPUTER SYSTEM PERFORMING DATA DEDUPLICATION

(71) Applicant: ORANGE, Paris (FR)

(72) Inventors: Pierre Obame Meye, Rennes (FR); Philippe Raipin Parvedy, Saint Ouen Des Alleux (FR)

(21) Appl. No.: 14/780,391

(22) PCT Filed: Mar. 20, 2014
(86) PCT No.: PCT/FR2014/050653

§ 371 Date: Sep. 25, 2015

(30) Foreign Application Priority Data
Mar. 28, 2013 (FR) 1352798

(51) Int. Cl. G06F 3/06

(52) U.S. Cl. CPC G06F 3/0641; G06F 3/0608; G06F 3/0683

(57) ABSTRACT

The invention relates to a method of storing data in a computer system (SYS) comprising a plurality of first devices (PC1, PC2) storing data belonging to respective users (U1, U2), and a second device (SS) suitable for managing the saving of data coming from first devices, said saving including a step of inter-user data deduplication, the method being characterized in that an intermediate device (I) is interposed between the first devices (PC1, PC2) and the second device (SS) so as to perform initially intra-user deduplication on the data for saving coming from first devices, and then to manage inter-user deduplication in co-operation with the second device (SS).

### TECHNICAL FIELD

The invention relates to a method of storing data in a computer system performs data deduplication.

It should be recalled that in computing, deduplication (also referred to as factoring or single instance storage) is a technique for saving data that consists in factoring identical data sequences in order to economize the amount of memory space used.

### STATE OF THE ART

Present network storage systems perform data deduplication prior to storage. Deduplication consists in detecting redundancy between data for saving in a computer system and data that has already been saved, so as to store only the difference. Thus, if a first device requests data to be stored on a second device, deduplication is performed. If the data for saving has already been saved in the second device in association with a third device, then only a reference to that data is created in association with the first device. Thus, when the first device seeks to access the data, the second device uses the reference and obtains the data. The second device can then transmit the data to the first device.

In certain applications, that deduplication technique provides a saving of about 90% in terms of storage space.

The deduplication operation takes place either at the source end, in this example in the first device, or else at the target end that is to perform the saving, in this example the second device. The second device is generally a storage server.

If deduplication is performed at the source end, i.e. on the first device, a client program installed in the first device performs deduplication prior to transmitting data for saving to the second device. That technique is effective in saving bandwidth at the first device.

If deduplication is performed in the second device, i.e. if the server, then the above-mentioned client server transmits the data for saving to the second device which performs deduplication. Under such circumstances, all of the data is transmitted; there is thus no bandwidth saving at the second device.

Several solutions exist for unifying data deduplication and confidentiality.

In a first solution known as “per-user encryption”, the first device encrypts the data for saving using a private key prior to transmitting it to the second device. It is assumed that the second device does not know the public key corresponding to the private key. It is also assumed that a plurality of first devices may request storage on the second device, each first device having its own private key and public key pair.

In such a configuration, the same data saved in the second device for the same user can be subjected to deduplication. However, the second device cannot detect that it is saving the same data for two different users since the second device has no knowledge of the public keys needed for decryption.

With that first solution, data confidentiality is ensured, but that method reduces the effectiveness of deduplication in the system since it prevents data being deduplicated between different users. Consequently, at the second device, there is no bandwidth saving and storage space is not managed in optimum manner since deduplication of data belonging to different users is not effective.

With that first solution, the client program does not return data that has already been transmitted and stored on the second device. Bandwidth is thus optimized at the first device.

A second solution relates to convergent encryption. Convergent encryption is an encryption procedure devised to enable deduplication to be performed on contents encrypted by different first devices, it being understood by different users. The second solution encrypts data as a function of its content. The general idea is that a user encrypts data with a hash function and then uses the results of the encryption for encrypting the data. In this way, the same data encrypted by two different users is identical after being encrypted; the second device can then perform deduplication on data belonging to different users. The second solution thus seeks to unify inter-user deduplication, i.e. deduplication between different users, and also to unify data confidentiality. Consequently, in the second device, bandwidth is not saved. However, storage space saving is better than when using per-user encryption, since inter-user deduplication is performed by the second device.

In the first device, the second solution provides a saving in bandwidth by means of the deduplication that is performed at the second device end.

The method that is the most reliable in terms of confidentiality from among the above-described existing approaches is the method using per-user encryption. Nevertheless, that reduces the effectiveness of deduplication considerably. In order to improve the effectiveness of deduplication and guarantee data confidentiality, convergent encryption is found to be better than the first solution. Nevertheless, recent work has shown that it is possible to compromise confidentiality when convergent encryption is used. It should be recalled that in the convergent encryption method, data corresponds to a data identifier that is calculated as a function of the data; the identifier and the data are intimately associated. The identifier is transmitted instead of the data so as to determine whether the data has already been stored in the second device; if so, i.e. if the second device is already storing the same identifier, the data is not transmitted.

In that convergent encryption method, it is the client program installed in the first device that creates the data identifier. Consequently, malicious attacks are possible. For example, a user may create a random identifier ID that is entirely independent of the data F for saving; whereas, it should be recalled that the identifier is supposed to have been calculated as a function of the data. The second device receives the ID/F pair (where ID is the identifier of the data and F is the data, e.g. a file F) and thus stores the ID/F pair. Subsequently, another user of another device seeks to store data F′; the client program of that other user calculates an identifier correctly on the basis of the data (e.g. a hash of the data) and obtains an identifier ID that is the same as the identifier used by the malicious device. The second device receives the identifier ID and observes that it already exists in memory. The second device thus replies to the first device that the data is already present and there is no need to upload the data. Subsequently, when the first device requests downloading of the data, the first device receives the data F′ from the malicious device and not the legitimate data F.

Another drawback is associated with the network being observed by a malicious third party. When a user saves data in the system, the user can observe the outgoing and incoming network traffic on the client device and can verify whether the data is indeed transmitted to the second device. If it is not transmitted, the user deduces that another user has already saved the data in the system. This makes it possible to identify the data that has already been stored by a storage system.

The invention provides a solution that does not present the drawbacks of the state of the prior art.

The Invention

To this end, in a functional aspect, the invention provides a method of storing data in a computer system comprising a plurality of first devices storing data belonging to respective users, and a second device suitable for managing the saving of data coming from first devices, said saving including a step of inter-user data deduplication, the method being characterized in that an intermediate device is interposed between the first devices and the second device so as to perform intra-user deduplication on the data for saving coming from first devices, and then to manage inter-user deduplication in co-operation with the second device.

It should be recalled that intra-user deduplication serves to perform deduplication on data from a single user, whereas intra-user deduplication serves to perform deduplication on data from users who may be different.

The presence of an intermediate device enables deduplication to be performed twice, once on data from a given user (intra-user), and also on data from different users (inter-user).

In the first device, this gives rise to a saving in bandwidth. When a user is saving, there is no need to send all of the data if the data has already been sent during an earlier stage. Only the difference between the previously stored data and the current data for saving needs to be transmitted.

Furthermore, in the second device, there is a saving in storage space. The second device performs inter-user deduplication and thus optimizes its storage space by storing only one instance of any given data. In the second device, confidentiality of the saved data is also ensured; the data is advantageously encrypted using the convergent encryption mode described in the paragraph on the state of the prior art. The second device thus guarantees data confidentiality for users; only authorized users can have access to the data in the clear.

It should also be observed that, in the present application, a “first device” relates equally well to a data processor device or to a client program.

In an implementation, in order to manage inter-user deduplication, the intermediate device performs the following steps:

a) a step of creating an identifier associated with data for saving as received from a first device; and

b) a transmission step during which the intermediate device transmits at least the identifier to the second device for managing inter-user deduplication of the data.

The data identifier saved on the second device is not created by the first device but by a trusted intermediate device. The identifier is thus no longer generated by the first device. This limits malicious attacks involving manipulating identifiers, as explained above.

In a second implementation, which may be implemented as an alternative to or together with the preceding implementation, in order to manage intra-user deduplication:

a) the first device creates a first identifier associated with data for saving; and

b) the first device transmits the identifier to the intermediate device for managing intra-user deduplication.

The first device thus manages only identifiers relating to its own data and not to data belonging to other users.

In another implementation, which may be implemented as an alternative to or together with the preceding implementation, the intermediate device stores correspondence between the identifiers associated with intra-user deduplication and the identifiers associated with inter-user deduplication. The device serves to establish correspondence between identifiers used for intra-user deduplication and identifiers used for inter-user deduplication. When the intermediate device receives an identifier of data to be saved from a first device and when that data has already been saved in the second device, the intermediate device can use the correspondence to recover the identifier of that same data as used by the intermediate device and by the second device for managing inter-user deduplication. In other words, the client program does not generate the identifiers associated with inter-user deduplication. A malicious attack using random identifiers, as described in the portion about the state of the prior art, is no longer possible because of the invention.

In another implementation, which may be implemented as an alternative to or together with the preceding implementations, the intermediate device is situated on a communications link through which the first device communications with the second device. In this way, the device does not change the path, usually the shortest path, that is followed by data exchanged between the first and second devices. The intermediate device is ideally situated in a location that is not accessible to a user. By way of example, the device may be situated within the network of a telecommunications operator.

As described below, an intermediate device is ideally a point of presence (POP) device suitable for aggregating data streams coming from a plurality of first devices. Such an aggregation device may for example be a point of presence (POP) in various digital subscriber line (xDSL) infrastructures. The advantage of using a point of presence POP is that it is a point through which data coming from or going to first devices must necessarily pass; consequently, the point of presence does not in any way change the length of the path between a user and the second device. Furthermore, by placing the intermediate device in points of presence (POPs), this guarantees that the data passes via an intermediate device that is out of the reach of users and completely secure.

Other aggregation devices exist, in particular fiber optic nodes (FONs) in an optical fiber network of a telecommunications operator.

In another implementation, which may be implemented as an alternative to or together with the preceding implementations, at the end of inter-user deduplication, the intermediate device transmits information about the saving performed, and in that the instant at which the information is transmitted is delayed, in particular if the data is already stored on the second device. By observing the time required for deduplication, it is possible under certain circumstances (in particular when the data is large in size) for a user to deduce that inter-user deduplication has taken place. In order to make inter-user deduplication completely transparent while not consuming resources, the intermediate device acts, where necessary, to add latency to the processing of a data write request so that the request lasts as long as would be required for normal storage of the data. In this way, a user cannot deduce whether data for storing has just been written to the second device or was already stored therein.

More generally, this other implementation makes inter-user deduplication entirely transparent for users, which is not true of presently-existing solutions.

In a hardware aspect, the invention provides a computer program including code instructions for performing the method according to any preceding claim, when the program is executed by a processor.

In another hardware aspect, the invention provides a processor-readable data medium storing a program including program code instructions for executing steps of the above-defined method.

In another hardware aspect, the invention provides a device comprising a communications module for communicating with a plurality of first devices having respective storage modules for storing data belonging to respective users, and with a second device suitable for managing saving of data coming from first devices, said saving including a step of inter-user data deduplication, the device being characterized in that it comprises:

a) a first module for managing intra-user deduplication on data for saving coming from first devices; and

b) a second module for managing inter-user deduplication in co-operation with the second device.

In another hardware aspect, the invention provides a computer system comprising a plurality of first devices having respective storage modules for storing data belonging to respective users, and a second device suitable for managing saving of data from first devices, said saving including a step of inter-user data deduplication, the system being characterized in that an intermediate device is interposed between the first devices and the second device, the intermediate device comprising:

a) a first module for managing intra-user deduplication on data for saving coming from first devices; and

b) a second module for managing inter-user deduplication in co-operation with the second device.

The invention can be better understood on reading the following description given by way of example and made with reference to the accompanying drawings, in which:

FIG. 1 shows a computer system for illustrating an implementation the invention.

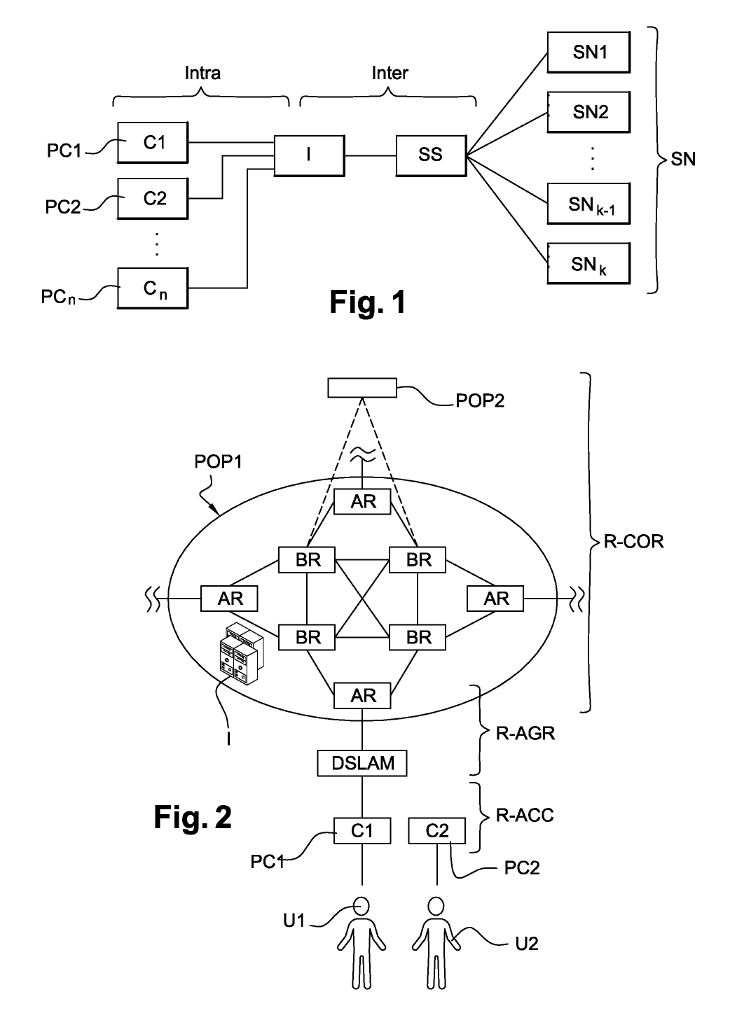

FIG. 2 is a detailed view of the system, and in particular of the intermediate device in an implementation of the invention.

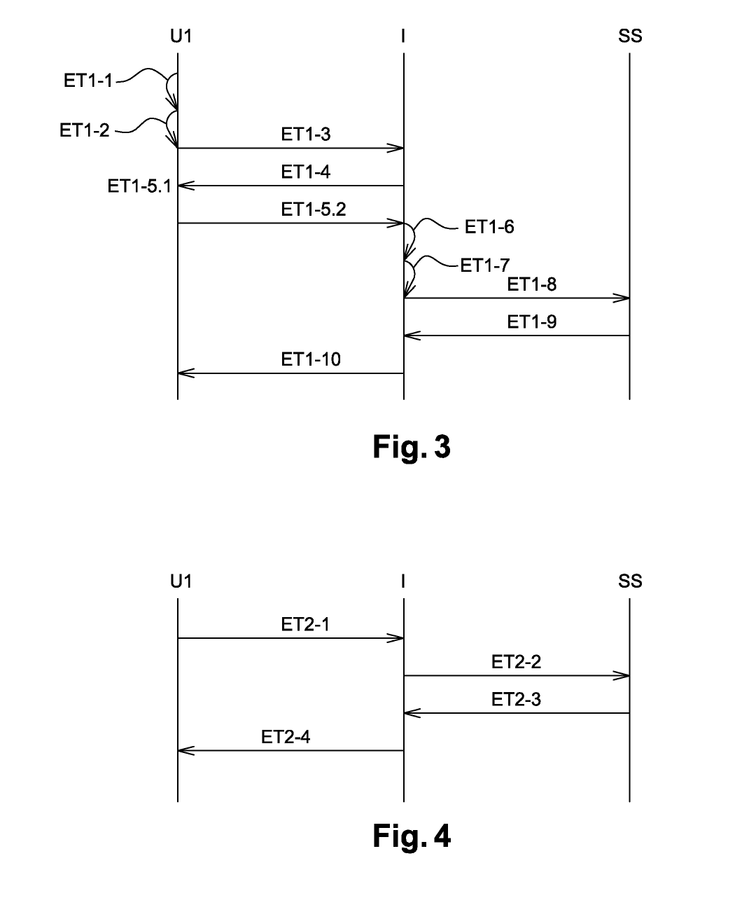

FIG. 3 is a diagrammatic view of the exchanges that place during a stage of writing data on a second device.

FIG. 4 is a diagrammatic view of exchanges that take place during a stage of reading data on a second device.

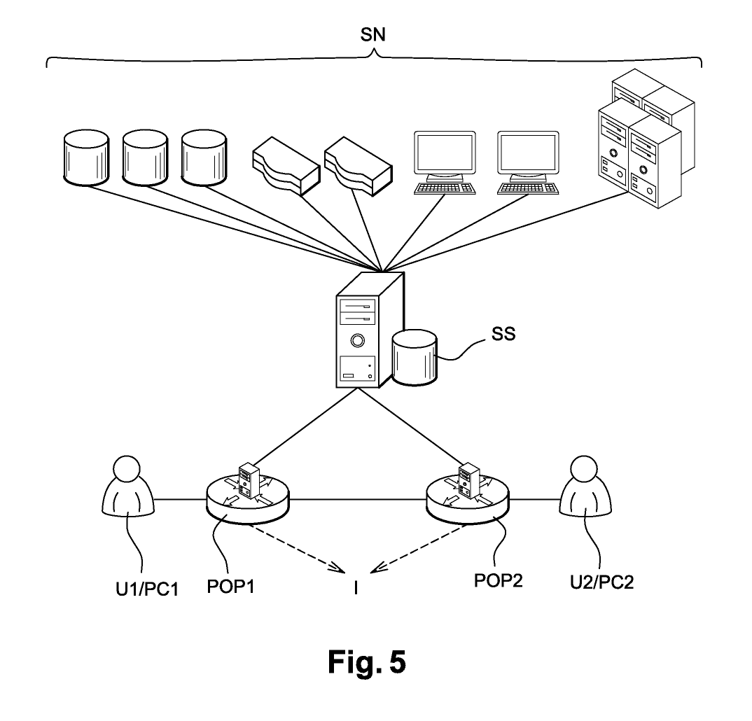

FIG. 5 is an overall view of the system in the implementation described.

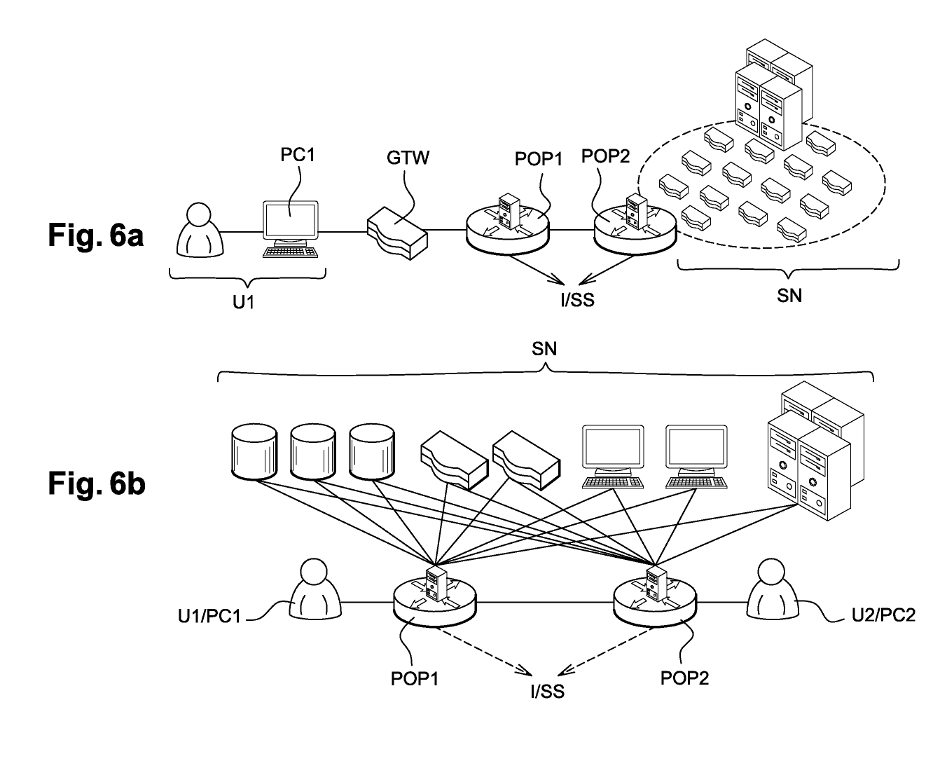

FIGS. 6a and 6b show another implementation in which the intermediate device performs both of the above-described stages.

### DETAILED DESCRIPTION OF AN IMPLEMENTATION ILLUSTRATING THE INVENTION

FIG. 1 shows a computer system SYS in which the invention can be performed. The system comprises a plurality of data processor devices (PC1, . . . , PCn).

In order to simplify the description, the following figures show only two devices, referred to as first devices PC1 and PC2.

In this implementation, the system is based on a DSL type network architecture of an access provider. The architecture comprises:
client programs C1 and C2 installed in the first devices PC1 and PC2 respectively;
an intermediate device I that performs data deduplication for a single user (intra-user); where an intermediate device corresponds to one or more client programs; and
a second device SS represented by a storage server; the storage server performs inter-user deduplication on data from a plurality of users. In this implementation, the second device SS also performs data storage, either locally or on storage nodes (SN1, ..., SNk).

It should be recalled that this DSL type architecture may be broken down in simplified manner into three layers, namely an access layer, an aggregation network, and a core network. These various layers are shown in FIG. 2. In this figure, there can be seen an access network R-ACC, an aggregation network R-AGR, and a core network R-CORR.

The access network R-ACC usually comprises gateways (home gateways) installed on client premises and digital subscriber line access multiplexers (DSLAMs) that are known to the person skilled in the art. Subscriber lines in a region coming from the gateways are aggregated in the DSLAMs. DSLAM multiplexers have the ability to aggregate numbers of subscribers lying in the range about 100 to several thousand.

The aggregation network R-AGR groups together the DSLAM multiplexers and the points of presence (POPs). The lines collected together by the DSLAMs are aggregated at a second level in the POPs.

Finally, the core network R-CORR has a plurality of points of presence (POPs). POPs can aggregate streams coming from tens of DSLAMs. It should be recalled that a point of presence (POP) comprises a set of interconnected routers at a common location (building, room, . . . ). They are provided with physical and software resources dedicated to routing. Two types of router are to be distinguished, namely access routers AR and core routers BR. The access routers are connected to the aggregation network. The access routers are in turn connected to the core routers.

Each access router within a POP is connected to at least two core routers BR in order to provide protection in the event of failures within a POP. The various core routers BR are interconnected in a mesh network. The POPs give access to the Internet protocol (IP) network of the Internet access provider.

Deduplication can be performed at various levels of data granularity, for example at file level, at block level, or at byte level. Below, data D is to be saved.

An implementation of a data writing stage is described with reference to FIG. 3. This implementation comprises a plurality of steps referenced ET1-k (k=1 to 10) in FIG. 3.

It is assumed that a user U1 with an identifier IDU seeks to save data D in a storage space SNk managed by the second device SS.

In the method, and with reference to FIG. 1, an intermediate device I manages intra-user deduplication INTRA, while the server SS manages inter-user deduplication INTER.

The location of the intermediate device in the network may vary; it may be situated in a first device PC1/PC2, in the second device SS, or in an intermediate device of the network. It can be seen below that an intermediate device is advantageously selected, in particular for the purpose of increasing bandwidth at the second device, since it is at this level that data volume is the greatest.

In this example, a POP multiplexer is the location selected for illustrating the implementation. A POP multiplexer has the advantage of being both a trusted device because it is situated in a trusted zone, namely within the core network; while also being located within the network as close as possible to the first devices.

The data D may be transmitted in the clear, i.e. in non-encrypted manner; nevertheless, in order to ensure confidentiality, in this example, the data is encrypted by means of an encryption algorithm known to the person skilled in the art.

Below, a primitive may be written as follows: Send(scr, dest, COMMAND, param_{—}1, param_{—}2, . . . , param_N)

This primitive is used to specify a command for transmitting parameters from a source “src”, e.g. a first device, to a destination “dest”, e.g. an intermediate device.

Below:
Hash(D) designates a hashing function and D designates the data to which the hashing function is applied;
Easym designates an asymmetrical encryption function; and
Esym designates a symmetrical encryption function.

In this example, each user U1 and U2 possesses a public key and a private key.

The steps are as follows:

During a first step ET1-1, in this example, the client program C1 of user U1 hashes the data D for sending:

HD=Hash(D)

In a second step ET1-2, the client program C1 of the user U1 optionally creates the identifier IDD of the data D that is to be used for managing intra-user deduplication in the intermediate device I. This step is optional but recommended since comparing each bit of the data, particularly when the number of bits is large, can be very lengthy and expensive in terms of consuming computer resources. Furthermore, the use of an identifier avoids any need for the first device to transmit all of the data if that data has already been saved.

In this example, since deduplication between the first device PC1 and the intermediate device I is intra-user deduplication, i.e. involving data belonging to the same user, the identifier is created in such a manner that collisions between different data identifiers created by the same user are not possible. For example, the identifier may be a hash taking account of the value HD created in step 1 and the identifier of the user IDU. The hashing function may be written as follows:

IDD=Hash(IDU, HD)

During a third step ET1-3, the client program C1 of the user U1 transmits the identifier IDD of the data D to the intermediate device in order to verify that it does not already possess this data D.

More precisely, the primitive as transmitted may have the following form:

Send(IDU, I, CHECK, IDD)

This primitive includes:
the identifier of the user IDU;
an intermediate identifier IDI;
the data identifier IDD; and
a CHECK command requesting verification of the presence or the name of the identifier IDD in the intermediate device.

During a fourth step ET1-4: on reception, the intermediate device I verifies in the data index of user U1 whether the identifier IDD does or does not exist:
if IDD exists in the index of the user U1, then the intermediate device I responds to the client program C1 of the user U1 that there is no need to transmit the data D. The operation of saving the data D terminates;
else, the intermediate device I responds to the client program C1 of the user U1 but requesting it to transmit the data, in this example the encrypted data, together with its encrypted key for decryption.

This step may be illustrated by the following syntax:

If index.get(IDU).contains(IDD)
Send(I, IDU, IDD, CHECK_RESPONSE, YES)

Else
Send(I, IDU, IDD, CHECK_RESPONSE, NO)

During a fifth step ET1-5.1, when the client program C1 of the user U1 obtains the response from the intermediate device I; if the identifier IDD already exists, then saving is considered as being done and the operation terminates.

If the identifier IDD does not exist, then the client program C1 of the user U1 acts during a step ET1-5.2 to transmit the encrypted data D together with its encrypted decryption key.

The client program C1 of the user U1 encrypts the data D with the key HD in order to obtain encrypted data DE, and then encrypts the key HD with its public key Ku_pub in order to obtain HDE so that only itself, i.e. the client program C1 of the user U1, has access to the decryption key in the clear. The client program C1 of the user U1 then transmits the encrypted data DE and the encrypted decryption key HDE.

These steps may be illustrated by the following syntax:

If IDD exists

End of saving (ET1-5.1)

Else (ET1-5.2)
DE=Esym(HD,D)
HDE=Easym(Ku_pub, HD)
Send(IDU, I, PUT, IDD, HDE, DE)

At this stage, the first stage of deduplication has terminated.

A second stage then begins during which inter-user deduplication is performed.

During a sixth step ET1-6, when the intermediate device I receives the data, it creates a hash of DE in order to create a system identifier IDD_sys for use in managing inter-user deduplication by the second device SS. Since all of the data is encrypted in the same manner by all of the users U1 and U2, two files that were equal prior to being encrypted will still be equal after encryption, and will thus have the same system identifier.

IDD_sys=Hash(DE)

During a seventh step ET1-7, the intermediate device I updates its index concerning saving IDD by U1 and the system identifier IDD_sys allocated to the data D.

Index.update(IDU, IDD, IDD_sys)

At this stage, in this example, at least three identifiers coexist in the intermediate device, namely the identifier IDU of the user U1, the identifier IDD of the data D, and the system identifier IDD_sys.

In an eighth step ET1-8, the intermediate device I verifies whether IDD_sys does or does not exist in its index:
if IDD_sys exists (in association with another user) within the system, that means that the data has already been stored on a storage node SNk and that there is no need to store it again. The intermediate device I then transmits only a reference of the data DE to the server SS together with the encrypted decryption key HDE;
if IDD_sys does not exist, then the data DE has not already been stored in the storage nodes SNk; DE and HDE are then transmitted to the server SS.

This step may be illustrated by the following syntax:

If IDD_sys exists
Send(I, FSS, PUT, IDU, IDD, IDD_sys, HDE)

Else
Send(I, FSS, PUT, IDU, IDD, IDD_sys, HDE, DE)

During a ninth step ET1-9, the server SS notifies the intermediate device I that saving has indeed been performed.

Send(FSS, I, PUT_ACK, IDU, IDD, IDD_sys, OK)

During a tenth step ET1-10, the intermediate device I notifies the client program of the user U1 of the end of saving D3.

This step may be illustrated by the following syntax:

Send(I, IDU, PUT_ACK, IDD, OK)

This writing stage may be followed by a stage of reading data that involves the intermediate device I. This reading stage is described below with reference to FIG. 4, and it comprises steps that are referenced ET2-j in FIG. 4.

The above-described steps illustrate the writing stage. The following steps illustrate a stage of reading the data D.

During a first step ET2-1 of this reading stage, the client program C1 of the user U1 transmits to the intermediate device I the identifier IDD of the data D that it is seeking to recover, namely IDD. This step may be illustrated by the following syntax:

Send(IDU, I, GET, IDD)

Thereafter, the intermediate device I searches for the identifier IDD in the index of the user U1.

If the identifier IDD exists in the data of the user U1, the intermediate device I searches for the system identifier IDD_sys that corresponds to the identifier IDD in a system index. The system index may be represented by means of a lookup table between the identifiers that result from intra-user deduplication, e.g. IDD, and system identifiers IDD_sys.

Once the system identifier IDD_sys has been found, the encrypted data DE and the encrypted decryption key D are recovered from the server SS during a second step ET2-2 and transmitted to the user U1 during a third step ET2-3. If the identifier IDD does not exist in the data of the user U1, a negative response is transmitted to the user U1 during a fourth step ET2-4 of this reading stage.

The above steps of this reading stage are summarized by the following code executed by the intermediate device I.

If Index Users.get(IDU).contains(IDD)
IDD_sys=Index_Users.getSystem_Index(IDU, IDD)
HDE,DE=Send(I, FSS, GET, IDU, IDD, IDD_sys) (ET2.2 and ET2.3)
Send(I, IDU, GET_RESPONSE, IDD, HDE, DE) (ET2.4)

Else
Send(I, IDU, GET_RESPONSE, IDD, NO) (ET2.4)

In the above, it can be seen that the intermediate device is advantageously located at a point of presence POP. However it is possible to envisage some other location.

Furthermore, the number of intermediate devices I is arbitrary. It is possible to envisage having a single intermediate device; nevertheless, in order to reduce the consumption of resources by an intermediate device, it is preferable to provide for intra-user deduplication to be managed on a plurality of intermediate devices, and for each intermediate device to be associated with a plurality of first devices.

From the above, it can also be seen, with reference to FIG. 5, that the point of presence POP and the storage server SS are distinct nodes of the network.

Nevertheless, with reference to FIG. 6a or 6b, it is possible for an intermediate device POP2 to act both as the intermediate device I for performing the deduplication operation and as the storage server SS.

FIG. 6a shows two intermediate devices, namely first and second devices POP1 and POP2. In this configuration, when the first intermediate device POP1 receives a request from a client program C1 that is associated therewith, e.g. from a client program included in a PC1 in the same geographical region, the intermediate device POP1 performs the data deduplication operation. When the second intermediate device POP2 receives a request from the first intermediate device POP1, the second intermediate device POP2 then acts solely as a storage server SS. In FIG. 6a, it should be observed that a home gateway GTW is situated between the first device PC1 and the point POP1.

FIG. 6b shows two intermediate devices, namely a first device and a second device POP1 and POP2. In this example, both devices serve both to deduplicate and to store on the storage nodes SN.

As described above for step 10, the intermediate device I notifies the client program of the user U1 that saving has ended DE. With reference to the state of the art, it is mentioned above that, by observing the network, a user can observe incoming and outgoing network traffic on the client device and verify whether data for saving is in fact transmitted to the second device. If not, it can then be deduced that another user has already saved the file in the system. This enables files that have already been saved by a storage system to be identified. In this configuration, in a variant, the instant at which the response is transmitted is delayed, in particular if the data has already been stored on the second device. The time required for deduplication varies depending on whether or not the data is already present in the second device. The instant of transmission is thus selected in such a manner that the overall time between transmitting the request and receiving the response in step 10 is more or less the same. This characteristic makes it possible to mask from the first device that inter-user deduplication has been performed. In another variant, the instant of transmission may be random, once again so as to mask the actual time required for processing the deduplication operation.

It should be observed that the intermediate device possesses the following modules (not shown in the figures) for performing the method of the invention:

a) a first module for managing intra-user deduplication on data for saving that comes from first devices; and

b) a second module for managing inter-user deduplication in co-operation with the second device.

It should be observed that the term “module” as used in this document may correspond either to a software component, or to a hardware component, or indeed to a set of hardware and/or software components, suitable for performing the functions described above for the module.

It is also specified that the above-described example is based on DSL architecture. Nevertheless, the invention may be performed in other architectures in which data deduplication is possible, e.g. an optical fiber network.

1. A method of storing data in a computer system (SYS) comprising a plurality of first devices (PC1, PC2) storing data belonging to respective users (U1, U2), and a second device (SS) suitable for managing the saving of data coming from first devices, said saving including a step of inter-user data deduplication, the method being characterized in that an intermediate device (I) is interposed between the first devices (PC1, PC2) and the second device (SS) so as to perform intra-user deduplication on the data for saving coming from first devices, and then to manage inter-user deduplication in co-operation with the second device (SS).

2. A data storage method according to claim 1, characterized in that in order to manage inter-user deduplication, the intermediate device performs the following steps:
a) a step of creating an identifier (IDsys) associated with data (DE) for saving as received from a first device; and
b) a transmission step during which the intermediate device transmits at least the identifier (IDsys) to the second device for managing inter-user deduplication of the data (DE).

3. A storage method according to claim 1, characterized in that in order to manage intra-user deduplication:
a) the first device creates a first identifier (IDD) associated with data (D) for saving; and
b) the first device transmits the identifier (IDD) to the intermediate device (I) for managing intra-user deduplication.

4. A storage method according to claim 2, characterized in that the intermediate device stores correspondence between the identifiers associated with intra-user deduplication and the identifiers associated with inter-user deduplication.

5. A storage method according to claim 1, characterized in that the intermediate device (I) is situated on a communications link through which the first device communications with the second device.

6. A storage method according to claim 5, characterized in that the intermediate device (POP) is a device on the link that is suitable for aggregating data streams from first devices.

7. A storage method according to claim 1, characterized in that, at the end of inter-user deduplication, the intermediate device (I) transmits information about the saving performed, and in that the instant at which the information is transmitted is delayed.

8. A computer program including code instructions for performing a method when the program is executed by a processor, the method of storing data in a computer system (SYS) comprising a plurality of first devices (PC1, PC2) storing data belonging to respective users (U1, U2), and a second device (SS) suitable for managing the saving of data coming from first devices, said saving including a step of inter-user data deduplication, the method being characterized in that an intermediate device (I) is interposed between the first devices (PC1, PC2) and the second device (SS) so as to perform intra-user deduplication on the data for saving coming from first devices, and then to manage inter-user deduplication in co-operation with the second device (SS).

9. A device (I) comprising a communications module for communicating with a plurality of first devices (PC1) having respective storage modules for storing data belonging to respective users (U1), and with a second device (SS) suitable for managing saving of data coming from first devices, said saving including a step of inter-user data deduplication, the device being characterized in that it comprises:
a) a first module for managing intra-user deduplication on data for saving coming from first devices; and
b) a second module for managing inter-user deduplication in co-operation with the second device (SS).

10. A computer system (SYS) comprising a plurality of first devices (PC1) having respective storage modules for storing data belonging to respective users (U1), and a second device (SS) suitable for managing saving of data from first devices, said saving including a step of inter-user data deduplication, the system being characterized in that an intermediate device is interposed between the first devices and the second device, the intermediate device (I) comprising:
a) a first module for managing intra-user deduplication on data for saving coming from first devices; and
b) a second module for managing inter-user deduplication in co-operation with the second device (SS).

11. A storage method according to claim 3, characterized in that the intermediate device stores correspondence between the identifiers associated with intra-user deduplication and the identifiers associated with inter-user deduplication.
